(19) United States
(12) Patent Application Publication
(10) Pub. No.: US 2009/0071942 A1
(43) Pub. Date: Mar. 19, 2009

(54) METHOD AND APPARATUS OF WELDING WITH ELECTRICAL STICKOUT

(75) Inventors: Jeff Kachline, Highland Heights, OH (US); Douglas Bull, Roswell, OH (US)

Correspondence Address: PAUL, HASTINGS, JANOFSKY & WALKER LLP, 875 15th Street, NW, Washington, DC, 20005, US

(73) Assignee: LINCOLN GLOBAL, INC., City of Industry, CA (US)

(21) Appl. No.: 11/855,202

(22) Filed: Sep. 14, 2007

(51) Int. Cl. B23K 9/173

(52) U.S. Cl. 219/74

(57) ABSTRACT

A method of welding includes continuously passing a MIG electrode through a welding tip and nozzle of a welding gun, where a stickout distance of the MIG electrode is maintained in the range of about 1¼ to about 2 inches during welding. Further, a length of the nozzle of the welding gun is such that a distance between the end of the nozzle of the end of the electrode is about ¼ inch to about ¾ inch.

### BACKGROUND OF THE INVENTION

1. Field of the Invention

Devices, systems, and methods consistent with the invention relate to a method and apparatus of welding with electrical stickout.

2. Description of the Related Art

During the process of gas shielded MIG (metal inert gas) welding a MIG electrode (or MIG wire) is passed through a welding gun and continuously advanced toward a work piece and melted in order to create the weld. During this process a shielding gas is also continuously passed through the welding gun so as to maintain a stable welding arc and maintain weld stability and quality. The distance between the work piece and the welding gun tip (from which the MIG wire exits the welding gun) is referred to as “stickout.”

To maintain a consistent weld with good weld quality, the stickout length of the MIG wire is to be maintained relatively constant. In typical MIG welding devices, the stickout length is between ½ and 1 inch. Further, to maintain a good weld quality and a consistent stickout length, the wire feed speed is to remain constant and has an upper limit. If the wire feed speed exceeds the upper limit problems with the welding process and weld quality will occur. For example, arc stability can be compromised. Even if the welding amperage was increased, to increase the melt flow of the electrode, the stickout length is such that the MIG wire would be burned back to the welding gun tip, further compromising the welding process.

Because of the need to improve weld productivity and weld deposition rates, there is a need to increase the wire feed speed of MIG welding processes over those conventional known and available.

### BRIEF SUMMARY OF THE INVENTION

In one aspect of the invention, a method of welding includes continuously passing a MIG electrode through a welding tip and nozzle of a welding gun, where a stickout distance of the MIG electrode is maintained in the range of about 1¼ to about 2 inches during welding.

In another aspect of the invention, a welding gun is provided which has a nozzle portion positioned at the welding end of the gun and a welding tip positioned, at least partially, within the nozzle. A MIG electrode is passed through both the welding tip and the nozzle toward a work piece to be welded. In an embodiment, the nozzle has a length such that when the MIG electrode has a stickout length of about 1¼ to about 2 inches during welding a distance between an end of the nozzle and an end of the MIG electrode is about ¼″ to about ¾″ inches.

As used in the present application, the terms “MIG electrode” and “MIG wire” are directed to typical welding wire or electrode used for MIG welding and are not intended to include self-shielding MIG wire, which uses a flux core to provide the shielding gas.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates an embodiment of a tip portion of a welding gun according to an embodiment of the present invention.

### DETAILED DESCRIPTION OF EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

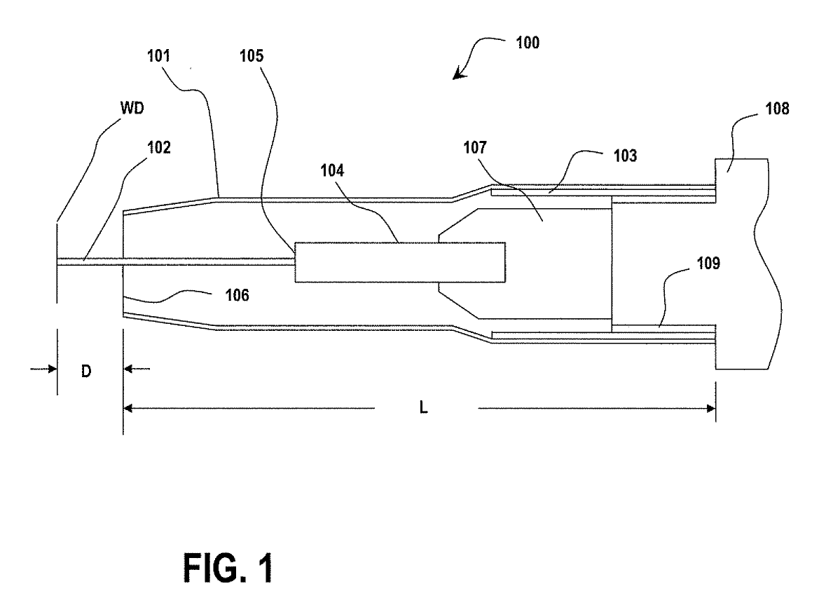

As shown in FIG. 1 the tip portion of a MIG welding gun 100 according to an embodiment of the present invention is shown. The gun 100 has a nozzle 101 which is placed over a nozzle insulator 103 and a nozzle insert 109, and is used to direct a shielding gas towards a work piece to be welded. The nozzle 101 is coupled to a gooseneck portion 108 of the gun 100 through the insulator 103 and the insert 109. In an embodiment of the invention the insert 109 is threaded onto the gooseneck portion 108 of the gun 100, or is otherwise secured. The insulator 103 electrically insulates the gooseneck portion 108 and nozzle insert 109 from the nozzle 101. It is noted however, that the present invention is not limited to the express embodiment shown in FIG. 1, and the nozzle 101 can be secured to or coupled to the gun 100 and gooseneck 108 by any known and/or conventional means.

Within the nozzle 101 is the welding tip 104 (also known as a contact tip) of the welding gun 100, where the welding tip is at least partially within the nozzle 101. The welding tip 104 is threaded into, or otherwise secured to, a diffuser 107 within the welding gun. The shielding gas passes through the diffuser 107 to shield the weld during the welding process. The MIG wire or electrode 102 passes through a hole in the welding tip 104 and extends toward a work piece (not shown) to be welded, and the welding tip 104 transfers the electrical current, needed for welding, to the electrode 102. Thus, the welding tip 104 aids in directing the electrode 102 towards the work piece. For the purposes of this disclosure, the stickout length of the electrode 102 is the distance between the face 105 of the welding tip 104 and the weld deposit WD which is at the tip of the electrode 102. The tip of the electrode 102 extends beyond the exit opening of the nozzle 101 by a distance D.

It is noted that for the purposes of the present invention, the construction of the overall welding gun 100 is that of conventional known and used welding guns for MIG welding. Further, the overall shape and materials used for the components such as the nozzle 101, tip 104, insulator 103, diffuser 107, gooseneck 108, insert 109, etc. are to be determined based on the operational and design parameters of the gun 100, except those discussed below.

In an embodiment of the present invention, the stickout length of the electrode 102 is in the range of about 1¼ to about 2 inches. In a further embodiment of the present invention, the stickout length is in the range of about 1⅝ to about 1¾ inch. This increased stickout length, coupled with an increased welding current allows for an increase in electrode feed speed over conventional MIG welding devices. The increased electrode feed speed allows for an increase in weld deposit rate, and thus increases welding efficiency.

In an embodiment of the present invention, the wire feed speed is in the range of about 500 to about 800 ipm (i.e. inches per minute). In a further embodiment, the wire feed speed is in the range of about 600 to about 800 ipm. In an embodiment of the present invention, by increasing the stickout length of the electrode 102 and the welding current, the wire feed speed can be increased. This increase in wire feed speed increases the overall deposition rate of the welding process.

In an embodiment of the present invention, the nozzle 101 has an increased length L over conventional nozzles. This increased length L is due to the increased stickout length of the electrode 102. By having an increased nozzle length L the shielding gas, typically used in a MIG welding process, is maintained around the extended length of the electrode 102, without having to increase the amount or rate of shielding gas flow from the nozzle. If the stickout length was increased without an increase in nozzle length it may be necessary to greatly increase the flow of the shielding gas to ensure that the arc and weld puddle are properly shielded. This results in an increased depletion rate of the shielding gas.

In an embodiment of the present invention, the nozzle 101 has a length L in the range of about 3½ to about 4 inches.

In a further embodiment of the present invention, the nozzle 101 has a length L such that the distance D between the weld deposit WD and the exit 106 of the nozzle is in the range of about ¼″ to about ¾″. By maintaining the distance D using a nozzle 101, according to an embodiment of the present invention, a welder may have improved comfort when welding with the extended stickout of the present invention. This is because, when welding with a MIG welding process, welders typically use the exit 106 (end) of the nozzle to gauge or estimate the distance to the work piece. Further, welders become accustomed to maintaining a certain distance between the nozzle exit 106 and the work piece, such that if there was a need to change that distance, it may cause welders to become uncomfortable during the welding process. Therefore, by extending the length of the nozzle 101, the distance D is maintained similar to what is conventional used in the welding industry, while the stickout length has been increased. It is also noted that the distance WD also represents the distance between the exit 106 and the end of the electrode 102, because during welding the end of the electrode 102 and the weld deposit WD are at essentially the same location. Thus, for the purposes of this application, these locations are considered to be the same.

By employing at least this embodiment of the present invention, a welder can maintain a comfort level with the welding process, while increasing the overall deposition rate of the weld process.

In an embodiment of the present invention, any commonly known or used shielding gas may be used during the welding operation. For example a 100% carbon dioxide or 75%/25% argon to carbon dioxide shielding gas can be used. The present invention is not limited in this regard, as the shielding gas is to be determined based on the welding parameters.

In a further embodiment of the present invention, the overall length of the welding tip 104 is reduced as compared to conventional welding guns, such that the extended stickout length of the present invention is achieved. The overall structure and configuration of the welding tip 104 is similar to that in conventionally known designs, except that the length is reduced. In an alternate exemplary embodiment, the welding gun 100 employs a combination of an extended nozzle 101 and reduced length tip 104 to attain the desired stickout length and/or the distance D.

The following Table provides exemplary welding procedures using an embodiment of the present invention and an electrode 102 having a 1/16 inch diameter.

TABLE 1

| Size | WFS (ipm) | Amps | Volts | Gas |
|---|---|---|---|---|
| 1/16 | 500 | 375 | 36 | 75% Ar/25% CO₂ |
| 1/16 | 600 | 420 | 38 | 75% Ar/25% CO₂ |
| 1/16 | 500 | 360 | 38 | 100% CO₂ |
| 1/16 | 600 | 410 | 42.5 | 100% CO₂ |

A method of welding in accordance with an embodiment of the present invention will now be described.

When welding in accordance with an embodiment of the present invention, the electrode 102 is continuously fed through the welding gun 100 and tip 104 at a rate of about 500 to about 800 ipm, and the stickout length of the electrode is maintained at a length of about 1¼ to about 2 inches. In another embodiment, the length is maintained at about 1⅝ to about 1¼ inches during the welding process. In a further embodiment, the feed rate of the electrode 102 in is the range of about 600 to about 800 ipm. Additionally, a shielding gas is continuously flowed through the nozzle during the welding process so as to provide sufficient shielding for the welding process.

In a further embodiment of the present invention, the distance D between the weld deposit WD and the exit 106 of the nozzle 101 is maintained in the range of about ¼″ to about ¾″, whereas the stickout length is maintained at a length of about 1¼ to about 2 inches. In another embodiment, the length is maintained at about 1⅝ to about 1¾ inches.

In an embodiment of the invention the shielding gas is flowed at a rate of about 35 to about 40 CFH. Of course the present invention is not specifically limited in this regard.

When welding in accordance with an embodiment of the present invention, welds are achievable which satisfy the AWS (American Welding Society) test classification A5.29-2005 requirements. Namely welds are achievable which satisfy the AWS weld metal composition requirements and tensile and yield strength requirements, including Charpy V-Notch requirements at both 0° F. and −20° F. Additionally, weld deposits are achievable which are below the 16 mL hydrogen/100 grams of weld deposit criteria.

While the invention has been particularly shown and described with reference to exemplary embodiments thereof the invention is not limited to these embodiments. It will be understood by those of ordinary skill in the art that various changes in form and details may be made therein without departing from the spirit and scope of the invention as defined by the following claims.

What is claimed is:

1. A method of welding, the method comprising:
continuously passing a MIG electrode through a welding tip and nozzle of a welding gun;
continuously passing a shielding gas through said nozzle; and
maintaining a stickout distance in the range of about 1¼ to about 2 inches during said welding;
wherein said stickout distance is measured between an exit face of said welding tip and a weld deposit.

2. The method of welding of claim 1, wherein said stickout distance is maintained in the range of about 1⅝ to about 1¾ inches.

3. The method of welding of claim 1, wherein said MIG electrode is continuously passed through said welding tip and said nozzle at rate of about 500 to about 800 inches per minute.

4. The method of welding of claim 1, wherein said MIG electrode is continuously passed through said welding tip and said nozzle at rate of about 600 to about 800 inches per minute.

5. The method of welding of claim 1, wherein a distance between an exit of said nozzle and said weld deposit is maintained in the range of about ¼ inch to about ¾ inch during said welding.

6. A method of welding, the method comprising:
continuously passing a MIG electrode through a welding tip and nozzle of a welding gun at an electrode feed speed of about 500 to about 800 inches per minute;
continuously passing a shielding gas through said nozzle; and
maintaining a stickout distance in the range of about 1¼ to about 2 inches during said welding;
wherein said stickout distance is measured between an exit face of said welding tip and a weld deposit, and
wherein a distance between an exit of said nozzle and said weld deposit is maintained in the range of about ¼ inch to about ¾ inch during said welding.

7. The method of welding of claim 6, wherein said stickout distance is maintained in the range of about 1⅝ to about ¼ inches.

8. The method of welding of claim 6, wherein said MIG electrode is continuously passed through said welding tip and said nozzle at rate of about 600 to about 800 inches per minute.

9. The method of welding of claim 6, wherein said shielding gas passes through said nozzle at a rate of about 35 to about 40 CFH.

10. A method of welding, the method comprising:
continuously passing a MIG electrode through a welding tip and nozzle of a welding gun at an electrode feed speed of about 500 to about 800 inches per minute;
continuously passing a shielding gas through said nozzle at a rate of about 35 to about 40 CFH; and
maintaining a stickout distance in the range of about 1¼ to about 2 inches during said welding;
wherein said stickout distance is measured between an exit face of said welding tip and a weld deposit, and
wherein a distance between an exit of said nozzle and said weld deposit is maintained in the range of about ¼ inch to about ¾ inch during said welding.

11. A welding gun, comprising:
a nozzle portion positioned at a welding end of said welding gun; and
a welding tip positioned, at least partially, within said nozzle portion through which a MIG electrode for welding passes;
wherein said MIG electrode also passes through said nozzle, and
wherein said nozzle has a length such that when said MIG electrode has a stickout length of about 1¼ to about 2 inches during welding a distance between an end of said nozzle portion and an end of said MIG electrode is about ¼ inch to about ¾ inch.

12. The welding gun of claim 11, wherein the stickout length is about 1⅝ to about 1¾ inches.

13. The welding gun of claim 11, wherein the nozzle portion has a length of about 3½ to about 4 inches.

14. The welding gun of claim 11, wherein said stickout length and said distance between said end of said nozzle portion and said end of said MIG electrode is maintained an electrode feed speed of about 500 to about 800 inches per minute.

15. The welding gun of claim 11, wherein said stickout length and said distance between said end of said nozzle portion and said end of said MIG electrode is maintained an electrode feed speed of about 600 to about 800 inches per minute.

16. A welding gun, comprising:
a means for directing a shielding gas at a work piece to be welded positioned at a welding end of said welding gun; and
a means for directing a MIG electrode at said work piece which is positioned, at least partially, within said means for directing said shielding gas;
wherein said MIG electrode also passes through said means for directing said shielding gas, and
wherein said means for directing said shielding gas has a length such that when said MIG electrode has a stickout length of about 1¼ to about 2 inches during welding a distance between an end of said means for directing said shielding gas and an end of said MIG electrode is about ¼ inch to about ¾ inch.

17. The welding gun of claim 16, wherein the stickout length is about 1⅝ to about 1¾ inches.

18. The welding gun of claim 16, wherein the means for directing said shielding gas has a length of about 3½ to about 4 inches.

19. The welding gun of claim 16, wherein said stickout length and said distance between said end of said means for directing said shielding gas and said end of said MIG electrode is maintained at an electrode feed speed of about 500 to about 800 inches per minute.

20. The welding gun of claim 16, wherein said stickout length and said distance between said end of said means for directing said shielding gas and said end of said MIG electrode is maintained at an electrode feed speed of about 600 to about 800 inches per minute.
